(19) United States
(12) Patent Application Publication
(10) Pub. No.: US 2007/0208623 A1
(43) Pub. Date: Sep. 6, 2007

(54) Method and system for user-driven advertising

(75) Inventors: Christopher D. Worden, Fort Lauderdale, FL (US); Kenneth D. Gilb, Fort Lauderdale, FL (US); Ole A. Pederson, Fort Lauderdale, FL (US)

Correspondence Address: ARENT FOX PLLC, 1050 CONNECTICUT AVENUE, N.W., SUITE 400, WASHINGTON, DC, 20036, US

(73) Assignee: The Blocks Company, LLC

(21) Appl. No.: 11/701,518

(22) Filed: Feb. 2, 2007

Related U.S. Application Data
(60) Provisional application No. 60/765,975, filed on Feb. 7, 2006.

(51) Int. Cl. G07G 1/14; G06F 3/048

(52) U.S. Cl. 705/14; 715/764; 715/810

(57) ABSTRACT

A method and system for computerized presentation of promotional content, which decreases or eliminates the intrusive and unsolicited nature of computer-related advertisements. The present invention allows providing of specific advertisements to a targeted group of people, while presenting a minimal intrusion in the workflow of both targeted and non-targeted users. Depending upon an action by a user, a menu of selectable items may be generated, including, among functional content items, an item of promotional content. The user may decide to investigate the promotional item by selecting it in the same manner that the user would select a functional item from the menu. Upon selection, the promotional content is displayed on the screen for the user to view and/or to take further action associated with the promotional content.

### CROSS-REFERENCE TO RELATED APPLICATIONS

This application claims the benefit of U.S. Provisional Application No. 60/765,975, entitled “User-Prompted Display of Promotional Content,” filed Feb. 7, 2006, the entirety of which is incorporated by reference herein.

### BACKGROUND OF THE INVENTION

1. Field of the Invention

The present invention relates generally to a computerized method and system for the presentation of advertising content. Specifically, the present invention relates to a computerized method and system for user-driven, such as menu-driven, presentation of advertising content.

2. Background of the Related Art

One problem with the presentation of computer-related and other software advertising content today is that the advertising content (also interchangeably referred to herein as “promotional content”) is typically unsolicited, frequently interrupts the workflow a user is engaged in, and usually requires an action by the user to eliminate the advertising content from the screen. As an example, most computer users today are all too familiar with the intrusive nature of pop-up, pop-under and banner-type advertisements that may appear on a computer screen as often as several times per second.

Another problem with the presentation of computer advertising content today is that it may be very difficult, if not impossible, to target a specific advertisement to a particular population group (e.g., as defined by gender, age, education or any other criterion). Thus, not only is computerized advertising content, by its very nature, intrusive and distracting to the user, but it becomes even more so when it is impossible to direct it to a particular group of users that may have a potential interest in the specific advertisement being presented. This problem is equally inconvenient and burdensome for computer users, computer advertisers and network/website operators alike, as each group has significant interest in having specific product or service-related promotional content targeted to a group of users that may have a potential interest in the specific product or service, rather than presenting the content to the public at large.

Nevertheless, with the advent of computer networks and the Internet, computer-related advertising has become a major source of revenue for Internet advertisers and network/website operators, and does not appear to be in decline. There is a general need in the art, therefore, for methods and systems that allow computerized presentation of promotional content, while at the same time avoiding the intrusive and unsolicited nature of current computer-related advertising content. There is a further need in the art for methods and systems that allow presentation of promotional content to a user without requiring an action by the user to eliminate the content from the screen, while permitting the user to take further steps to reveal the actual nature of the advertisement, should the user be so inclined. There is a further need in the art for methods and systems for providing advertising content to a targeted group of people, while presenting minimal intrusion in the workflow of both the targeted and non-targeted groups of users.

### SUMMARY OF THE INVENTION

The present invention solves the above-identified needs, and others, by providing a method and system for computerized presentation of promotional content, while at the same time avoiding the intrusive and unsolicited nature of current computer-related advertising content. Further, the present invention allows presentation of promotional content to a user without requiring user action for elimination of the content from the screen, while permitting the user to take further steps to reveal the actual nature of the advertisement, should the user be so inclined. In addition, the present invention allows advertising content to be provided to a targeted group of people, while presenting a minimal intrusion in the workflow of both the targeted and non-targeted groups of users.

The present invention includes a method and system for providing promotional content within, for example, any software that permits user-selectable items, such as a menu of selectable functions or other items to be performed by the software. In one embodiment, depending on the context of the workflow in which the user is engaged, the menu of selectable items may include, among the content items for the software functionality (interchangeably referred to herein as “functional content items”), an item of promotional content (interchangeably referred to herein as a “promotional content item”). The user may choose to investigate the promotional item by selecting it in the same manner that the user would select a functional item from the menu. Upon selection, the promotional content will be provided on the screen for the user to view and/or to take further action associated with the promotional content. The user may, however, decide not to pursue the promotional item, and to select a functional item instead. Upon such a user selection, in one embodiment, the item of promotional content will disappear from the screen, along with all of the remaining choices in the menu, without requiring additional action from the user.

It will be appreciated by one of ordinary skill in the art that the present invention may be added at the development stage of any software program, or may be added to existing software programs as a separate add-on module.

Other objects, features, and advantages will be apparent to persons of ordinary skill in the art from the following detailed description of the invention and the accompanying drawings.

### BRIEF DESCRIPTION OF THE FIGURES

For a more complete understanding of the present invention, the needs satisfied thereby, and the objects, features, and advantages thereof, reference now is made to the following description taken in connection with the accompanying drawings.

FIG. 1 is an illustration of a Graphic User Interface (“GUI”) screen in accordance with an embodiment of the present invention, wherein a list of selectable items within a software program is displayed, each selectable item representing either a functional or promotional content item;

FIG. 2 is an illustration of a GUI screen in accordance with an embodiment of the present invention, wherein a list of selectable items within a software program is displayed, each selectable item representing either a functional or promotional content item, wherein a user is in the process of selecting a functional item;

FIG. 3 is an illustration of a GUI screen in accordance with an embodiment of the present invention, wherein a list of selectable items within a software program is displayed, each selectable item representing either a functional or promotional content item, wherein a user is in the process of selecting a functional item;

FIG. 4 is an illustration of a GUI screen in accordance with an embodiment of the present invention, wherein a list of selectable items within a software program is displayed, each selectable item representing either a functional or promotional content item, wherein a user is in the process of selecting an item of promotional content;

FIG. 5 is an illustration of a GUI screen in accordance with an embodiment of the present invention, wherein a list of selectable items within a software program is displayed, each selectable item representing either a functional or promotional content item;

FIG. 6 is an illustration of a GUI screen in accordance with an embodiment of the present invention, wherein a list of selectable items within a software program is displayed, each selectable item representing either a functional or promotional content item, wherein an item of promotional content has been selected and the selected promotional content has been displayed;

FIG. 7 is an illustration of a GUI screen in accordance with an embodiment of the present invention, wherein a list of selectable items within a software program is displayed, each selectable item representing either a functional or promotional content item, wherein the promotional content is targeted to a specific population group;

FIG. 8 is a flowchart illustrating various steps in a method of displaying promotional content according to one embodiment of the invention;

FIG. 9 illustrates a block diagram of various computer system components for use with an exemplary implementation of a system for menu-driven advertising, in accordance with an embodiment of the present invention;

FIG. 10 illustrates a block diagram of various network system components for use with an embodiment of the present invention; and

FIG. 11 presents an example open system architecture, in accordance with an embodiment of the present invention.

### DETAILED DESCRIPTION

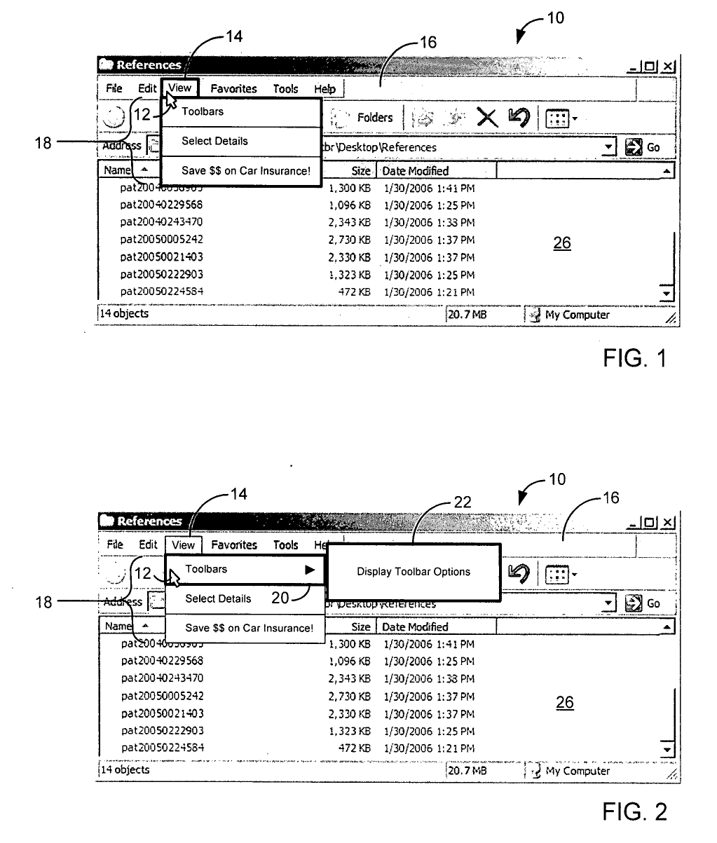

Preferred embodiments of the present invention and their features and advantages may be understood by referring to FIGS. 1-11, like numerals being used for like corresponding parts in the various drawings.

Referring now to FIGS. 1-4, shown therein are GUI screens depicting various elements of an illustrative embodiment of the present invention. Although FIGS. 1-4 show a computer user interface window 10, it will be readily understood by those of ordinary skill in the art that the present invention may be implemented using a personal computer (PC), a laptop computer, or other computer terminal, a kiosk, a wireless mobile telephony device, personal digital assistant (PDA), interactive television, or any other device that has a screen or other data delivery device and an input/output device.

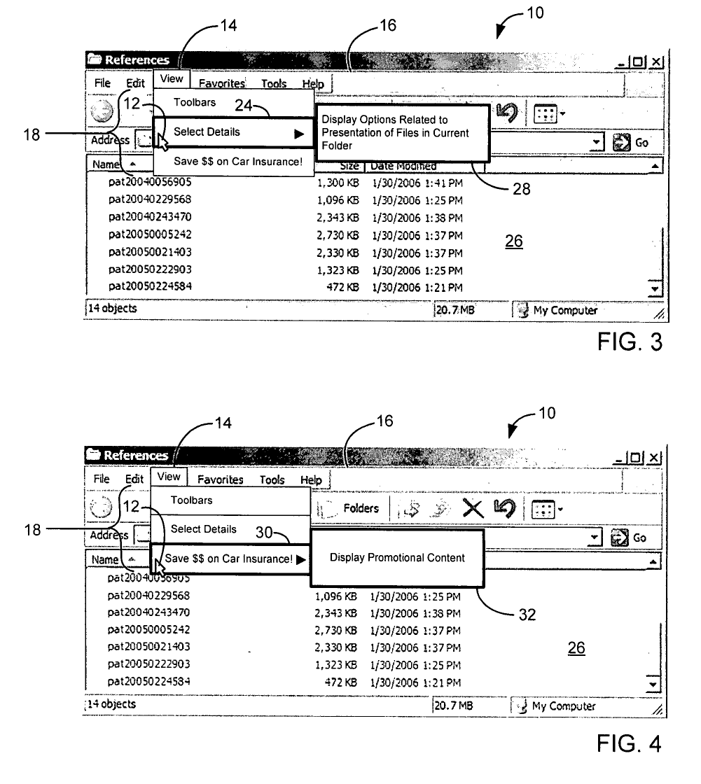

In the embodiment shown in FIGS. 1-4, user action directs screen cursor 12. For example, in FIG. 1 the cursor 12 is located over button 14, i.e., the “View” button 14, which is available along the toolbar 16 within the user interface window 10. Upon user selection of the “View” button 14, e.g., by clicking a mouse button or by simply locating the cursor over the “View ” button 14, a drop-down menu 18 appears and displays a list of selectable items. Among the selectable items displayed in drop-down menu 18 are one or more items representing software functions that may be performed, and one or more selectable items that represent promotional content. The user can direct cursor 12 to select a functional content item, e.g., “Toolbars” 20 in FIG. 2, which leads to the appearance of “Display Toolbar Options” screen box 22 as shown in FIG. 2, or “Select Details” 24 in FIG. 3, which, in turn, leads to the display of “Display Options Related to Presentation of Files in Current Folder” screen box 28. Alternatively, the user can direct cursor 12 to select a promotional content item, e.g., “Save $$ On Car Insurance” 30, shown in FIG. 4, which leads to the appearance of “Display Promotional Content” screen box 32.

One of ordinary skill in the art will appreciate that further windows may be nested or cascaded in association with the drop-down menu 18, “Toolbars” item 20 and “Display Toolbar Options” 22 in FIG. 2; “Select Details” 24 and “Display Options Related to Presentation of Files in Current Folder” screen box 28 in FIG. 3; and “Save $$ On Car Insurance” 30 and “Display Promotional Content” screen box 32 in FIG. 4. One of ordinary skill in the art will further appreciate that each user-selectable window, drop-down or other menu, screen or dialog box, or the like represents one or more operations that may be performed by the system upon selection by the user.

In addition, it will be readily understood by those of ordinary skill in the art that the user actions or user selections referred to herein may refer to the manual depressions of buttons on a cursor-position controller such as a mouse having left and right buttons, or may refer to mere movements of such a controller with or without regard to whether buttons are clicked (when not so clicked, also interchangeably referred to herein as “hovering”). Also, it will be appreciated that, while drop down menus are shown for illustrative purposes, other selection options may be provided for listing or otherwise allowing user view and/or selection. Furthermore, actions of the user referred to herein may refer to rotations of a tracking-ball type cursor controller, depressions of directional keys on a keypad, the touching of a touch-sensitive user input device such as a touch-pad or touch-sensitive screen, or manipulation of any other input/output device. Thus, actions of the user referred to herein relate generally to receipt of one or more user inputs by a host system, such that presentations and displays occurring responsive to such actions are appreciated by the user as occurring under the control and influence of the user.

Thus, in FIG. 3, for example, further to user action, cursor 12 is hovering over a “Select Details” selectable item 24 that represents one or more functions that control options for the listing of files displayed within the viewing area 26 of the window 10. Upon selection by the user of “Select Details” item 24, screen box 28 appears on the screen and displays information related to the one or more functions that are represented by the “Select Details” item 24. In this example, screen box 28 and any additional windows nested or cascaded in association with the window 28 and the item 24 present the user with information and controls for selecting the details displayed for each file listed in the viewing area 26. As shown in FIG. 3, the file name, the size, and the last date of modification are displayed for each file listed. Other types of information such as the file type of each listed file may be added to the details displayed by way and by use of functions represented by the selectable item 24 and the information displayed in the window 28.

In the example shown in FIG. 4, further to user action, cursor 12 is hovering over selectable item “Save $$ On Car Insurance” 30, representing promotional content. Responsive user action, e.g., selection of selectable item 30, screen box “Display promotional Content” 32 appears on the screen and displays promotional content. In this example, selectable item 30 represents promotional content related to automobile insurance. The promotional content displayed may include information identifying an insurance provider and may include hyperlinks to one or more websites, for example. Further windows nested or cascaded in association with screen box 32 may be further opened responsively to further actions of the user. Thus, according to this embodiment of the invention, distribution of promotional content to consumers may be accomplished by user selection of item 30, wherein the user continues to maintain control of the interaction and the navigation through promotional content represented by the item 30.

In the example shown in FIG. 4, selectable item 30, which represents promotional content, appears in a list displayed by a drop-down menu. The display of item 30, which represents promotional content, and the display of window 32, which displays the promotional content, are conveniently prompted and dismissed by actions of the user. As previously discussed, the selectable item 30 first appears upon user selection of the “View” button 14. Should the user direct the cursor 12 to other areas of window 10, such as, to locations of other buttons on toolbar 16, window 30 and the listing of selectable items displayed therein disappear from the screen. It should be understood that other selectable items representing promotional content may appear in other drop down menus associated with other buttons. Thus, promotional content is displayed with minimal inconvenience to the user as the user navigates about the window 10, and about other windows, boxes, menus, or the like, similarly displayed.

It will be understood by those of ordinary skill in the art that the software within which promotional content may be displayed, may include any types of software, such as an operating system, an application that runs concurrently or in conjunction with an operating system, that runs without regard to an operating system, or any other software that is capable of displaying promotional content. It will be further understood by those of ordinary skill in the art that the promotional content displayed may include text, images, sound, universal resource locators (URLs), short videos/commercial clips and/or be presented in any other format that is suitable or appropriate for advertising content.

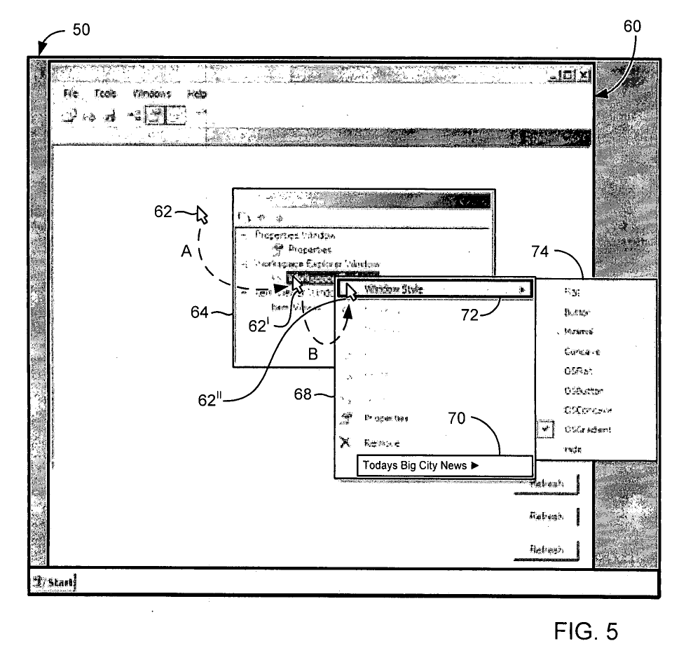

Referring now to FIG. 5, therein shown is a GUI screen depicting various elements of another embodiment of the present invention. In FIG. 5, a general window 50 generated under the control of an operating system has therein a particular window 60 that represents a software application running concurrently or in conjunction with the operating system. In this embodiment, the user controls the movement of cursor 62 within the area of window 60, and within additional windows nested or cascaded in association with window 60.

For example, upon user selection of an item within window 60, window 64, hierarchically subordinate to window 60, appears on the screen and displays selectable items that represent functions. Sub-window 64 may open, e.g., responsive to a right-click of a mouse button at general a position of the cursor 62. Upon selection by the user of a selectable item when the cursor is disposed at a second location, 62′ (the movement of the cursor from location 62 to 62′ indicated by dotted arrow A), an additional sub-window 68, which is subordinate to sub-window 64, opens and displays several selectable items, all of which represent respective functional content items, except for a single selectable item 70, which represents a promotional content item In the example shown in FIG. 5, the user has chosen to pursue one or more functions represented by the selectable item 72 (corresponding to cursor location 62″, the movement of the cursor from location 62′ to 62″ indicated by dotted arrow B) within the sub-window 68, and has not chosen to view promotional content represented by the selectable item 70. Thus, upon selection by the user of a selectable item when the cursor is disposed at a second location, 62″, an additional sub-window 74 opens, and the user may move the cursor therein to select or perform functions available therein. As illustrated in this example, the user may optionally refrain from prompting the presentation of promotional content, such as that represented by the selectable item 70. Therefore, the user is not unduly inconvenienced by the display of unsolicited items representing promotional content.

In one embodiment, to further preserve the convenience of the user, only a limited number of selectable items representing promotional content may be displayed concurrently. For example, among the selectable items available in the sub-window 68, only the item 70 represents promotional content. Each of the other illustrated selectable items, such as the item 72, represents one or more functions within the software program that can be performed by the user. It should be understood that, although the sub-window 68 in FIG. 5 displays only the single promotional content item 70, other embodiments of the invention relate to displaying several such items at once. In some embodiments, such additional promotional content may also only be provided in response to user selection or actuation of an item, thereby further limiting the intrusiveness of the advertising.

According to another embodiment of the invention, selectable items representing functions are easily distinguished from promotional items due to spatial arrangement of the items. For example, in the exemplary user interaction portrayed in FIG. 5, promotional content item 70 appears at a margin, i.e., the bottom margin, of the list of selectable items displayed within the sub-window 68. Thus, the user finds selectable items representing functional content items uninterruptedly grouped together, spatially separated from selectable items that represent promotional content, and which are thereby easily distinguished from such promotional content items. Nonetheless, the selectable item(s) that represent promotional content are proximate to the selectable items that represent functions and, as such, are positioned in a region of the display that likely will be examined by the user, thereby adding to the value of such promotional content.

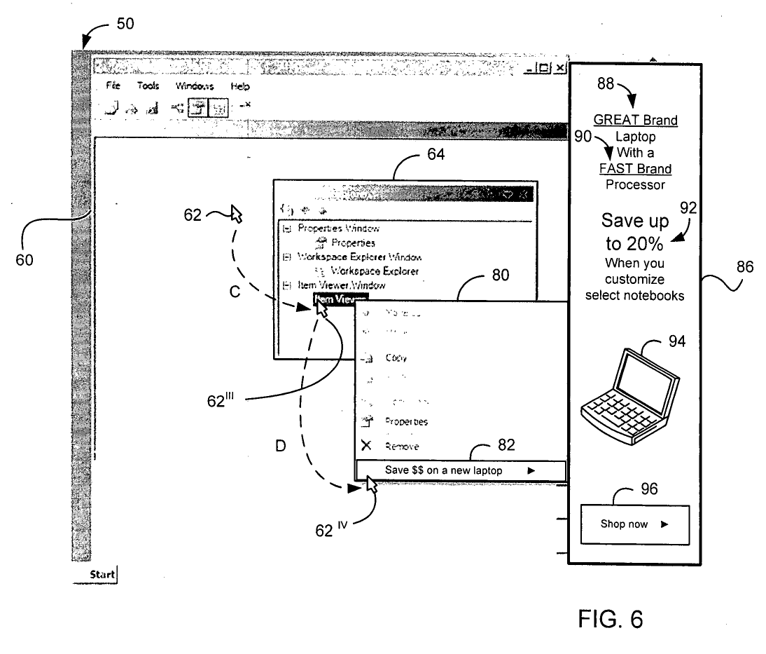

A subsequent stage of the example shown in FIG. 5 is portrayed in FIG. 6. In FIG. 6, upon user selection of an item at a third location, indicated at cursor position 62′″ (the movement of the cursor from a general position 62 indicated by dotted arrow C), the appearance of sub-window 80 occurs, which displays a list of selectable items, including several items representing functions and an item 82 representing promotional content, within window 60. Further user selection of promotional content item 82 causes the appearance of sub-window 86, which displays the promotional content represented by the selectable promotional content item 82. In this example, the promotional content relates to savings available with the purchase of a laptop computer. The promotional content includes textual content 88 identifying the manufacturer of the available computer, and textual content 90 identifying the manufacturer of the processor that comes within the available computer. The names of such manufacturers optionally appear as hyperlinks that lead to further information, for example, by way of the respective websites of the manufacturers. The promotional content also includes enticing textual content 92 regarding the amount of savings available, for example, as a percentage of the purchase price, and graphical content 94 depicting the product that is offered. A hyperlink 96 having the caption “Shop now” is displayed so that a user can optionally consider a purchase by viewing further information.

In one embodiment, selectable items representing different promotional content are displayed in different lists or menus. For example, the selectable item representing promotional content may merely alternate between the items of promotional content as different lists are requested by a user. In one example, in which promotional content exists for companies A, B and C, a selectable item representing promotional content for company A may be displayed, e.g., in a first menu; a selectable item representing promotional content for company B may be displayed, e.g., in a second menu; a selectable item representing promotional content for company C may be displayed, e.g., in a third menu; and a selectable item representing promotional content for company A may again be displayed, e.g., in a fourth menu.

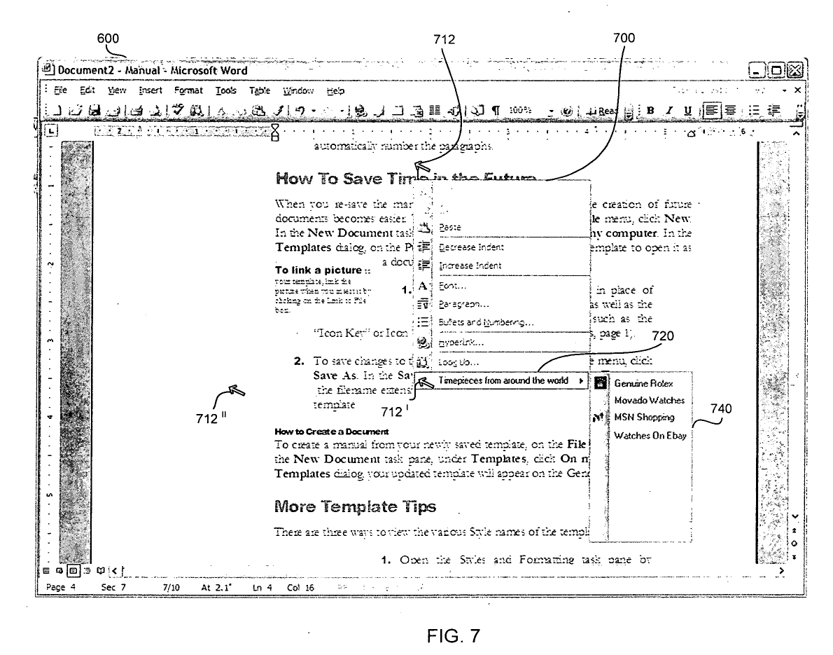

An embodiment of the present invention directed to the concept of targeting advertising content to specific population groups will now be described in reference to the example shown in FIG. 7. In this example, upon selection by the user (e.g., by hovering or clicking a mouse button) of the word “Time” in a Microsoft Word® document, located at the location of cursor 712 in FIG. 7, a pop-up menu 700 appears on the screen, listing a number of selectable functional content items and selectable promotional content item 720. As can be seen from the figure, promotional content item 720 is entitled “Timepieces from around the world,” as the method and system of the present invention made the inference that, if a user selects the word “Time,” that user may be interested in advertisements for timepieces. If the user is not interested in advertisements for timepieces, the user may select a functional item from pop-up menu 700, or otherwise continue the workflow the user was involved in prior to the appearance of pop-up menu 700. If the user displays an interest in viewing timepiece advertisements, however, the user may select selectable promotional content item 720 at cursor location 712′, and may further choose options that may appear on pop-up menu 740 or otherwise continue the process of viewing and selecting various items of promotional content associated with selectable promotional content item 720.

To terminate the process of viewing and selecting promotional content items, the viewer may simply move the cursor away from pop-up menus 720 and 740, and any other nested, embedded or otherwise associated menus with menus 720 and 740 to a different location on the screen 600, such as location 712″. Pop-up menus 720 and 740 may automatically disappear from the screen 600 upon the passage of a predetermined time interval after moving the cursor to location 712″. Alternatively, another user action may be required to terminate the process of viewing and selecting promotional content items.

It will be recognized by those of ordinary skill in the art that any other criterion may be used to select the type of promotional content to be displayed. For example, based on successive user-specific actions, such as successively selecting and/or deselecting functional and promotional items, different menu choices may be downloaded in real time. Furthermore, in accordance with one embodiment of the present invention, items of promotional content may be downloaded via a wide area network from a pool of available items.

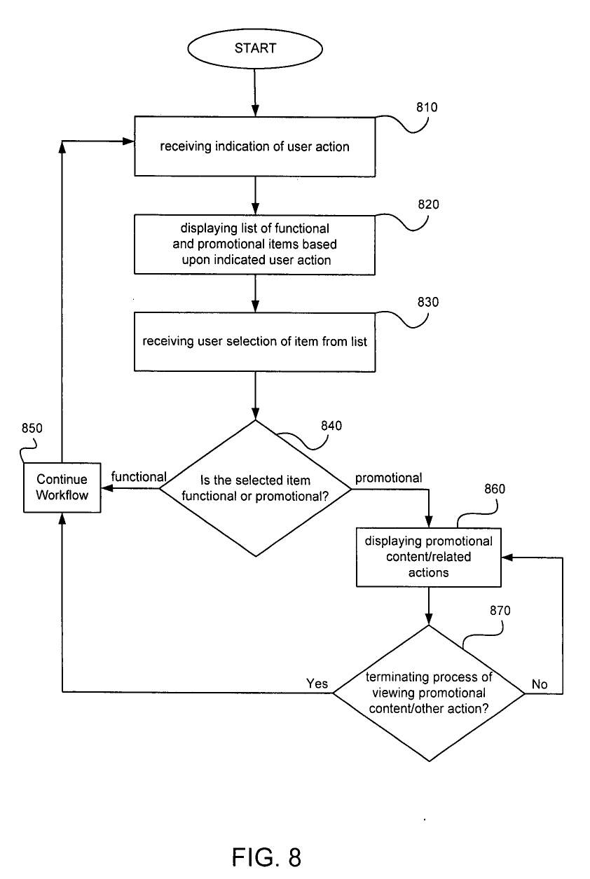

Referring now to FIG. 8, therein shown is a flowchart for a method of displaying promotional content according to an exemplary embodiment of the invention. The method includes receiving an indication of a user action 810, such as selecting a button on the screen or hovering over a particular location on the screen. Upon receiving the indication of user action 810, a list of functional and promotional items is displayed 820. Next, a user selection 830 of an item on the displayed list is received. If the received user selection 840 is that of a functional item, user workflow continues 850 without interruption by an exhibited advertisement. If the received user selection 840 is for a promotional item, the promotional content associated with the promotional content item is displayed on the screen, and/or the user may take other actions, as appropriate 860. Upon terminating the process of viewing promotional content and related actions 870, the workflow the user was involved in prior to viewing the promotional content continues 850.

As described above, FIG. 8 is a flowchart of an exemplary method for use with, systems and program products, in accordance with embodiments of the invention. It will be understood that each block or step of the flowchart, and combinations of blocks in the flowchart, can be implemented by computer program instructions. These computer program instructions may be loaded onto a computer or other programmable apparatus to produce a machine, such that the instructions that execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture, including instruction means that implement the function specified in the flowchart block(s) or step(s). The computer program instructions may also be loaded onto a computer or other programmable apparatus to cause a series of operational steps to be performed on the computer or other programmable apparatus to produce a computer implemented process, such that the instructions that execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems that perform the specified functions or steps, or combinations of special purpose hardware and computer instructions.

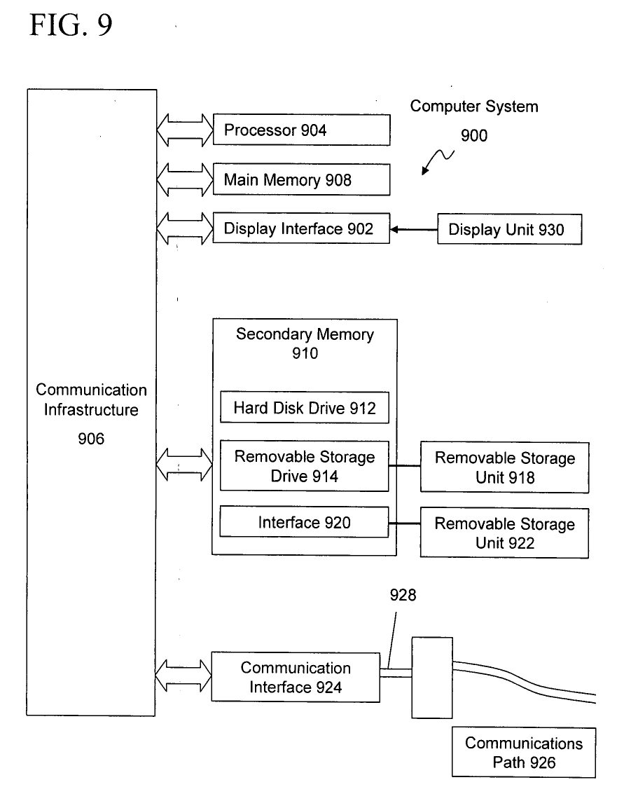

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 900 is shown in FIG. 9.

Computer system 900 includes one or more processors, such as processor 904. The processor 904 is connected to a communication infrastructure 906 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on the display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative embodiments, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 914, a hard disk installed in hard disk drive 912, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 904 to perform the features of the present invention. Accordingly, such computer programs represent controllers of the computer system 900.

In an embodiment where the invention is implemented using software, the software may be stored in a computer program product and loaded into computer system 900 using removable storage drive 914, hard drive 912, or communications interface 924. The control logic (software), when executed by the processor 904, causes the processor 904 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In one exemplary embodiment, the system for user-driven advertising may be implemented, for example, as a Microsoft.net® desktop application program (Microsoft.net® is made by Microsoft® Corporation of Redmond, Washington), which may reside on a computer hard drive, database or other repository of data, or be uploaded from the Internet or other network (e.g., from a PC, minicomputer, mainframe computer, microcomputer, telephone device, PDA, or other device having a processor and input and/or output capability). It will be recognized by those skilled in the art, however, that any available software tool capable of implementing the concepts described herein may be used to implement the system and method of the present invention.

It will be apparent to those of ordinary skill in the art, that the method and system of the present invention may be implemented as an application-specific add-on to a program, or as a standalone application.

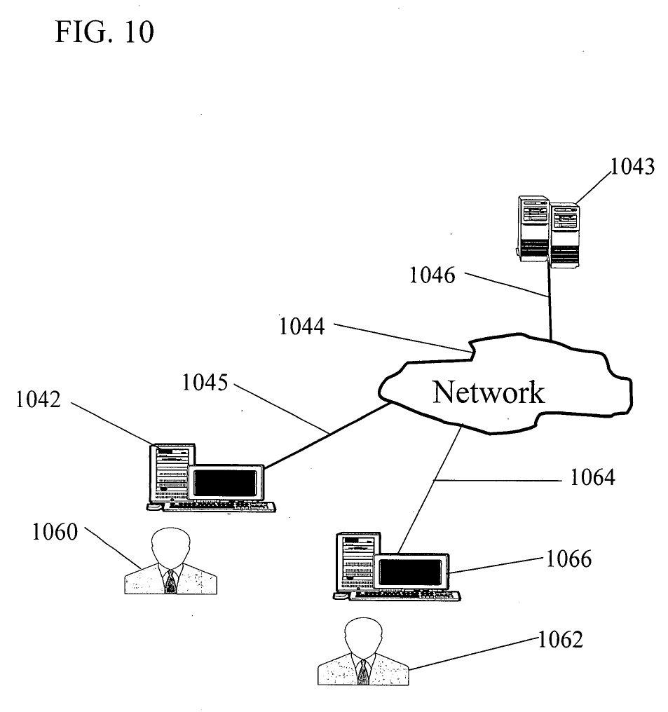

As shown in FIG. 10, in an embodiment of the present invention, some data for use in the system is, for example, input by one or more accessor(s) 1060, 1062 (also referred to interchangeably herein as “user(s)”) via a terminal(s) 1042, 1066, such as a PC, minicomputer, mainframe computer, microcomputer, telephonic device, or wireless device, such as a hand-held wireless device coupled to a server 1043, such as a PC, minicomputer, mainframe computer, microcomputer, or other device having a processor and a repository for data and/or connection to a processor and/or repository for data, via, for example, a network 1044, such as the Internet or an intranet, and couplings 1045, 1046, 1064. The couplings 1045, 1046, 1064 include, for example, wired, wireless, or fiberoptic links. In another embodiment, the method and system of the present invention operate in a stand-alone environment, such as on a single terminal.

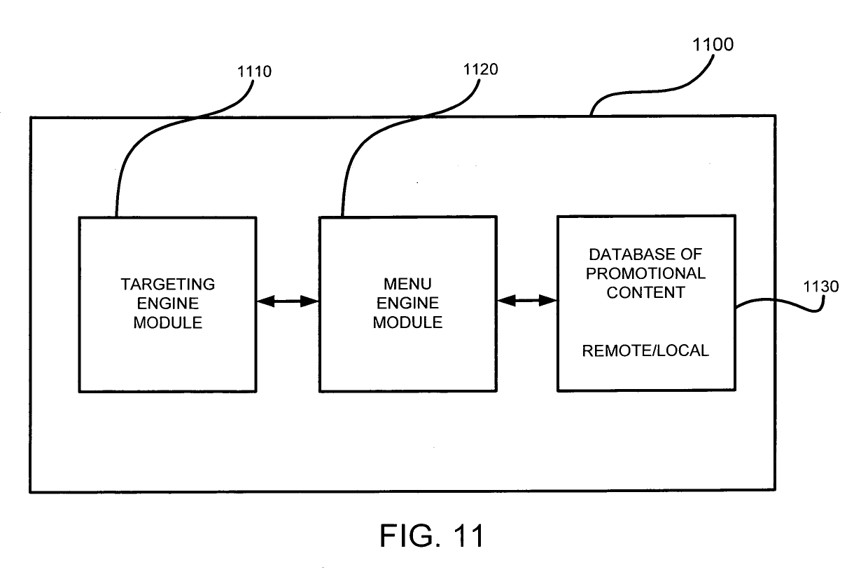

One embodiment of the present invention is based on an open system architecture 1100, as shown in FIG. 11. In this embodiment, the system for user-driven advertising includes Targeting Engine Module 1110, Menu Engine Module 1120, and a Database of Promotional Content 1130. It will be apparent to those of ordinary skill in the art that Targeting Engine Module 1110 may use any criterion to target advertisements to a particular group of people that may be interested in the targeted advertisements. As described above, the targeting feature of the present invention, in some embodiments, serves the double goal of reducing unsolicited and intrusive advertisements (e.g., all other advertisements that may not be associated with the particular criterion chosen), while targeting particular advertisements to a specific group of people who may have an interest in the particular advertisements (e.g., based on user profiles for users purchasing the software in which the present invention is embedded).

It will further be recognized by those of ordinary skill in the art that Menu Engine Module 1120 for generating a list of selectable items may be software application-specific and/or may be based on any algorithm (e.g., based on user-specific information, on succession of user-specific actions, on advertisement revenue, or other factors). The actual advertising content that is displayed upon user selection of a promotional content item may be displayed based upon similar or different criteria.

It will further be apparent to those of ordinary skill in the art that displayed promotional content may be acquired from a Database 1130 or other repository, which may be stored within a proximal data storage device co-located with or resident within the device or system that hosts the software application, and/or may be acquired from a remote data storage device such as that of a server via a network such as the Internet, a local area network, a wide area network, and/or via any type of communication device or system, capable of delivering content.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

1. A method of user-driven advertising, the method comprising:
receiving an indication of an action by a user in a software program;
displaying a list of selectable items based on the action by the user, the list comprising at least one promotional content item;
receiving a selection by the user of an item from the list; and
if the selected item from the list is the at least one promotional item, displaying promotional content associated with the at least one promotional content item.

2. The method of claim 1, wherein the list of selectable items further comprises at least one functional content item.

3. The method of claim 2, further comprising:
if the selected item from the list is the at least one functional content item, continuing workflow of the software program without interruption by promotional content.

4. The method of claim 1, wherein the at least one promotional content item is chosen based on information about the user.

5. The method of claim 1, wherein the at least one promotional content item is chosen based on an algorithm.

6. The method of claim 1, wherein the selection by the user of an item from the list comprises hovering over the item with a user selection device.

7. The method of claim 1, wherein the displayed promotional content associated with the at least one promotional content item further comprises a list of promotional content items.

8. A system for user-driven advertising, the system comprising:
means for receiving an indication of an action by a user in a software program;
means for displaying a list of selectable items based on the action by the user, the list comprising at least one promotional content item;
means for receiving a selection by the user of an item from the list; and
means for displaying promotional content associated with the at least one promotional content item, if the selected item from the list is the at least one promotional item.

9. The method of claim 8, wherein the list of selectable items further comprises at least one functional content item.

10. The method of claim 9, further comprising:
if the selected item from the list is the at least one functional content item, continuing workflow of the software program without interruption by promotional content.

11. A system for user-driven advertising, the system comprising:
a processor;
a user interface functioning via the processor; and
a repository accessible by the processor;
wherein an indication of an action by a user in a software program is received via the user interface;
wherein a list of selectable items based on the action by the user is displayed via the user interface, the list comprising at least one promotional content item;
wherein a selection by the user of an item from the list is received via the user interface; and
wherein promotional content associated with the at least one promotional content item, if the selected item from the list is the at least one promotional item, is displayed from the repository.

12. The system of claim 11, wherein the processor is housed on a terminal.

13. The system of claim 12, wherein the terminal is selected from a group consisting of a personal computer, a minicomputer, a main frame computer, a microcomputer, a hand held device, and a telephonic device.

14. The system of claim 11, wherein the processor is housed on a server.

15. The system of claim 14, wherein the server is selected from a group consisting of a personal computer, a minicomputer, a microcomputer, and a main frame computer.

16. The system of claim 14, wherein the server is coupled to a network.

17. The system of claim 16, wherein the network is the Internet.

18. The system of claim 16, wherein the server is coupled to the network via a coupling.

19. The system of claim 18, wherein the coupling is selected from a group consisting of a wired connection, a wireless connection, and a fiberoptic connection.

20. The system of claim 11, wherein the repository is housed on a server.

21. The system of claim 20, wherein the server is coupled to a network.

22. A computer program product comprising a computer usable medium having control logic stored therein for causing a computer to perform user-driven advertising, the control logic comprising:
first computer readable program code means for receiving an indication of an action by a user in a software program;
second computer readable program code means for displaying a list of selectable items based on the action by the user, the list comprising at least one promotional content item;
third computer readable program code means for receiving a selection by the user of an item from the list; and
fourth computer readable program code means for displaying promotional content associated with the at least one promotional content item, if the selected item from the list is the at least one promotional item.

23. The method of claim 22, wherein the at least one promotional content item is chosen based on information about the user.

24. The method of claim 22, wherein the at least one promotional content item is chosen based on an algorithm.
